(19) United States
(12) Patent Application Publication
(10) Pub. No.: US 2007/0138705 A1
(43) Pub. Date: Jun. 21, 2007

(54) Shape manipulation of nanostructures

(75) Inventors: William Mickelson, San Francisco, CA (US); Shaul Aloni, Albany, CA (US); Steve Konsek, Boston, MA (US); Alex Zettl, Kensington, CA (US); Thomas Yuzvinsky, Berkeley, CA (US)

Correspondence Address: Fulbright & Jaworski L.L.P., 666 Fifth Avenue, New York, NY, 10103, US

(73) Assignee: The Reagents of the University of California, Oakland, CA (US)

(21) Appl. No.: 11/559,539

(22) Filed: Nov. 14, 2006

Related U.S. Application Data
(63) Continuation-in-part of application No. PCT/US05/28232, filed on Aug. 8, 2005.
(60) Provisional application No. 60/737,248, filed on Nov. 15, 2005.

(51) Int. Cl. B29C 35/08

(52) U.S. Cl. 264/405; 425/174.4

(57) ABSTRACT

A method for reshaping a nanostructure. The method includes: providing a nanostructure having an initial shape; applying energy from a non-chemical energy source to the nanostructure; and thereby reshaping the nanostructure to a reshaped geometry different from the initial shape. The nanostructure may additionally be optionally cleaned with the application of energy from the non-chemical energy source.

This application is a continuation-in-part of co-pending International Patent Application No. PCT/US05/28232 filed Aug. 8, 2005, and also claims priority under §19(e) from U.S. provisional patent application 60/737,248 filed Nov. 15, 2005, each of which are incorporated herein by reference.

### STATEMENT AS TO RIGHTS TO INVENTIONS MADE UNDER FEDERALLY SPONSORED RESEARCH AND DEVELOPMENT

This invention was made with U.S. Government support under Contract Number DE-AC02-05CH11231 between the U.S. Department of Energy and The Regents of the University of California for the management and operation of the Lawrence Berkeley National Laboratory. The U.S. Government has certain rights in this invention.

### BACKGROUND OF THE INVENTION

The present invention relates to nanostructures, more particularly to techniques for directly manipulating at least a part of a nanostructure, and still more particularly manipulating, cleaning, and reforming of a part of a nanostructure, such as a multi-walled carbon nanotube using an energy-enabled processes.

Nanomaterials such as nanotubes, nanowires, nanocrystals and supramolecular structures (i.e., structures comprised of multiply-conjoined molecular and atomic units) have been proposed as the basic building blocks for a new generation of electronic and mechanical systems, including memory and logic components (e.g., see T Rueckes, K. Kim, E. Joselevich, G. Y Tseng, C. L. Cheung, and C. M. Lieber, Science 289, 94 (2000), C. P. Collier, E. W. Wong, M. Belohradsky, F. M. Raymo, J. F. Stoddart, P. J. Kuekes, R. S. Williams, and J. R. Heath, Science 285, 391 (1999); A. Bachtold, P. Hadley, T. Nakanishi, and C. Dekker, Science 294, 1317 (2001); S. J. Tans, A. R. M. Verschueren, and C. Dekker, Nature 393, 49 (1998)); light emitting devices and photodetectors (e.g., see M. H. Huang, S. Mao, H. Feick, H. Q. Yan, Y. Y. Wu, H. Kind, E. Weber, R. Russo, and P. D. Yang, Science 292, 1897 (2001); F. Duan, Y. Huang, Y. Cui, J. F. Wang, and C. M. Lieber, Nature 409, 66 (2001); J. A. Misewich, R. Martel, P. Avouris, J. C. Tsang, S. Heinze, and J. Tersoff Science 300, 783 (2003); J. F. Wang, M. S. Gudiksen, X. F. Duan, Y. Cui, and C. M. Lieber, Science 293, 1455 (2001)); electromechanical actuators (e.g., see A. M. Fennimore, T. D. Yuzvinsky, W. Q. Han, M. S. Fuhrer, J. Cumings, and A. Zettl, Nature 424, 408 (2003)); biological imaging technologies (e.g., see M. Bruchez, M. Moronne, P. Gin, S. Weiss, and A. P. Alivisatos, Science 281, 2013 (1998)) and drug delivery systems (e.g., see S. R. Sershen, S. L. Westcott, N. J. Halas, and J. L. West, Journal of Biomedical Materials Research 51, 293 (2000)). With their small size and high surface-to-volume ratio, nanostructured devices can be faster, cheaper, more efficient, and more sensitive than their conventional analogues.

The same attributes that make nanostructures attractive, however, can also cause undesirable effects. Behavior can be irreproducible and can exhibit time-dependence or changes in chemical sensitivity from one device to the next without any macroscopic change in fabrication methods or operating environment. Understanding of the device variability has been limited by a lack of techniques that can efficiently correlate minute changes in a device's structure with its operational behavior.

As-grown nanostructures in general, as well as carbon and other elemental or compound nanotubes and nanowires, are far from perfect. They are typically covered by surface contaminants such as amorphous feedstock material, and various other adsorbed chemical species, some of which are remnants of the synthesis process used to form the nanostructured device. Existing techniques that are available for cleaning nanotubes include bulk thermal and bulk chemical methods; cleaning via high temperature oxidation; and chemical cleaning, all of which suffer from poor process efficiencies.

In addition, the chemical bonding structure of nanotubes often has undesirable defects that could compromise the mechanical integrity, as well as the electrical and thermal responses, of the nanotubes. In addition to the need for addressing these issues of as-grown nanotubes, there are also times when nanotubes having unusual shapes are desired. For example, certain applications call for elbow-shaped, hook-shaped, U-turn-shaped, corkscrew-shaped and other so-called unnatural-shaped nanotubes. These unnatural shaped-nanotubes are difficult, if not nearly impossible, to reliably produce. Reliable nanotube reforming methods and manufacturing methods for unnatural-shaped geometries are unknown.

There is, therefore, a need to reliably, directly and locally clean previously-formed carbon nanotubes. There is also a need to be able to directly and locally manipulate and reform the geometric properties, or shape, of nanotube and nanotube bundles.

### BRIEF SUMMARY OF THE INVENTION

The present invention provides systems and methods for electrically contacting and locally manipulating nanostructures, such as nanotubes, nanotube bundles, and nanowires. The systems and methods of the present invention allow selected and bulk nanotubes to be modified directly, and thus allow for the cleaning, reforming, structurally modifying, and improving nanotubes, nanotube bundles, and nanowires via an energy enabled process. In one example the energy enabled process is that of Joule resistive heating due to electrical current flow through a nanostructure. In addition, the systems and methods in accordance with the embodiments of the present invention provide for in-situ analysis of nanostructure cleaning and reforming methods and results of the use of such methods.

In accordance with one embodiment of the present invention, by applying electrical current through one or more carbon nanotubes, surface contamination is cleansed from the interior and exterior of the nanotubes. The application of electric current causes resistive Joule heating, which enables the surface cleaning, where electrical current resistively heats the nanotubes causing the surface contamination to evaporate or sublimate. In addition to the cleaning of the nanotubes, the carbon nanotubes may also be annealed by way of an electrical-current-induced heating. The heating mechanism causes defects to be annealed out of the nanotubes creating a more faultless nanotube.

Additionally, the resistive heating the nanotubes, using the same electrical-current-induced heating, is used to render permanent structural transformations in the nanotubes. In one embodiment, once a kink, or other structural deformation is made in the nanotube, by heating the nanotube with the Joule heating effect, the structural deformation is made permanent. This technique, which involves first deforming and then annealing to make the deformation permanent, enables the reformation of nanotubes into any desirable form. The thermal setting effect of such annealing on kinked or straight nanotubes or wires is useful to effectively cast the respective element into a form that is maintained until an annealing temperature is once again reached.

In one aspect, the present invention provides a method for directly manipulating a nanostructured device. The method includes providing a response producing member; operatively coupling the nanostructured device with the response producing member; manipulating the nanostructured device by applying electric current to the nanostructured device through the response producing member to cause manipulations of the nanostructured device; and monitoring the manipulations using a high-resolution imaging device, while applying the electric current. With this aspect, it is possible to: bend or mold (one or more) nanotubes or (one or more) nanowires to a specific geometry that is desired; reduce the temperature of the specific geometry; and leave the geometry in a stable configuration of the desired specific geometry.

As used herein a nanostructured device refers to a carbon nanotube, carbon nanotubes, a silicon nanotube, a silicon nanowire, silicon nanotubes, silicon nanowires, a gold nanowire, or gold nanowires.

In accordance with another embodiment, the present invention provides a force- or torque-deflection device acting upon a nanostructure so as to induce a deformation of a controlled nature. The force-deflection device includes a mounting chuck for holding a nanostructure, a deflection device for imparting a force vector upon the nanostructure, wherein the force vector is measured by the deflection device, a controller for manipulating the nanostructure, through controlled movements of the deflection device, where the controller measures the force vector, and a current source connected to the mounting chuck and the deflection device, controlling a current passing through the nanostructure.

For a further understanding of the nature and advantages of the invention, reference should be made to the following description taken in conjunction with the accompanying drawings.

### BRIEF DESCRIPTION OF THE DRAWINGS

FIG. 1A is a SEM image of a membrane device with several MWCNTs contacted by gold electrodes. The membrane itself is not visible in the SEM and appears black.

FIG. 1B is a TEM image of a membrane with three MWCNT devices indicated by arrows. A regular array of holes is pre-etched into the membrane to allow higher resolution imaging. The scale bar is 2 μm.

FIG. 2A shows gold nanoparticles covering the as-fabricated device.

FIG. 2B shows the device is partially cleaned by the application of 1.7V (˜190 μA).

FIG. 2C shows that increasing the voltage to 1.72V cleans the device further, and that the Si₃N₄ membrane is beginning to deteriorate.

FIG. 2D shows that raising the voltage to 1.9V cleans the device of all gold nanoparticles. It also shows that the membrane under the center section of the MWCNT is gone.

FIG. 2E shows where the MWCNT has undergone wall-by-wall breakdown and five walls have been removed from the center section.

FIG. 2F shows further breakdown removes all but two complete walls and one partial wall from the center of the MWCNT.

FIG. 2G shows that the final walls have failed and the MWCNT is broken into two sections. The scale bar is 100 nm.

FIG. 3A is graph showing the current and voltage across the device as a function of time. The current decreases in a step-wise fashion with remarkably equal current steps of approximately 13.5 μA. Current steps calculated from a geometric model are shown on the right side of the plot.

FIG. 3B shows a TEM image of the MWCNT showing the loss of five walls. The scale bar is 10 nm.

FIG. 4 shows high resolution TEM images of the MWCNT before (above) and after (below) current induced annealing of kink.

FIG. 5 shows a TEM images where FIG. 5A shows an image of 2 bent MWCNTs on the verge of buckling; and FIG. 5B shows the same MWCNTs after current of 180 micro Amps was passed through it creating a permanent kink, shown in FIG. 5C.

FIGS. 6A-E are a sequence of frames from a video taken in the TEM of an AFM tip (left) being deflected from an axially compressed MWCNT; FIG. 6F is a graph of force versus axial compression of the MWCNT of FIGS. 6A-E.

### DETAILED DESCRIPTION OF THE INVENTION

Definitions

Chemical energy means the energy of a chemical compound which, by the law of conservation of energy, must undergo a change equal and opposite to the change of heat energy in a reaction; the rearrangement of the atoms in reacting compounds to produce new compounds causes a change in chemical energy.

Non-chemical energy means energy deriving from a source other than that of a chemical reaction, i.e. not deriving from a chemical energy source. Examples of non-chemical energy could include application of electromagnetic fields, laser heating, laser heating with one or more femtosecond pulses, electromagnetically heating, resistive Joule heating with direct or alternating currents, eddy current-induced resistive Joule heating, electric field dissipation, ion bombardment, electron bombardment, ponderomotive forces, Lorentz forces, and laser tweezers.

Introduction

The present invention provides systems and methods for selectively applying energy and locally manipulating one or more nanostructures. Nanostructures may commonly comprise nanotubes, nanotube bundles, nanowires, or nanocrystals. The methods taught here may additionally be applicable to proteins, DNA, RNA, mRNA, large molecular weight molecules, biomolecules, as well as polymers, which may also include nylons. The systems and methods of the present invention allow selected and bulk nanotubes to be modified directly, and thus allow for the cleaning, reforming, and structurally modifying and improving nanotube and nanotube bundles via an application of non-chemical energy. In addition, the system and method in accordance with the embodiments of the present invention provide for in-situ analysis of nanotube cleaning and reforming. As used herein the nanotubes can be a carbon nanotube, carbon nanotubes, a silicon nanotube, a silicon nanowire, silicon nanotubes, silicon nanowires, a gold nanowire, or gold nanowires.

In accordance with another embodiment, the present invention provides a force-deflection device acting upon a nanostructure. The force-deflection device includes a mounting chuck for holding a nanostructure, a deflection device for imparting a force vector upon the nanostructure, wherein the force vector is measured by the deflection device, a controller for manipulating the nanostructure, through controlled movements of the deflection device, where the controller measures the force vector, and a current source connected to the mounting chuck and the deflection device, controlling a current passing through the nanostructure.

The embodiments of the present invention have numerous industrial utilities, including: the cleaning of surface contamination from nanotubes; the annealing of lower quality nanotubes into higher quality ones; the reshaping of nanotubes by structurally deforming and annealing in general, and for use as objects for manipulating nanoscale objects and scanned probe microscopy. For example, a nano-sized hook object may be formed using the techniques in accordance with the embodiments of the present invention, and then used to manipulate other nano-sized objects. Furthermore, a structurally modified or preferentially deformed or kinked nanotube is useable as an integrated one-piece atomic force microscope cantilever and tip, allowing for higher resolution and faster scan rates for such a microscope.

The examples set forth below describe various combinations of in-situ monitoring and manipulations of nanotubes which embody the present invention.

### EXAMPLE 1

In this example, the live imaging of operating multiwall carbon nanotube (MWCNT)-based electronic devices was performed by high-resolution transmission electron microscopy (TEM). The measurements were used to correlate electronic transport with changes in device structure. Surface contamination, contact annealing, and sequential wall removal were observed. The measured temperature profiles confirmed diffusive conduction in MWCNTs in the high bias limit. This example teaches a technique and a platform for cleaning, annealing, monitoring and analyzing nanoscale systems, where geometric configuration and electronic transport are intimately connected.

First an electron-transparent device that is operable inside a TEM was constructed. The electron transport device, which is used as a response producing member, was fabricated using an approach that is based on techniques used to construct silicon nitride (Si₃N₄) membranes as electron-transparent supports for TEM imaging (e.g., see S. B. Chikkannanavar and D. E. Luzzi, Nano Letters 5, 151 (2005); A. Y. Kasumov, Khodos, II, P. M. Ajayan, and C. Colliex, Europhysics Letters 34, 429 (1996), and A. Kis, G. Csanyi, J. P. Salvetat, T N. Lee, E. Couteau, A. J. Kulik, W. Benoit, J. Brugger, and L. Forro, Nature Materials 3, 153 (2004)).

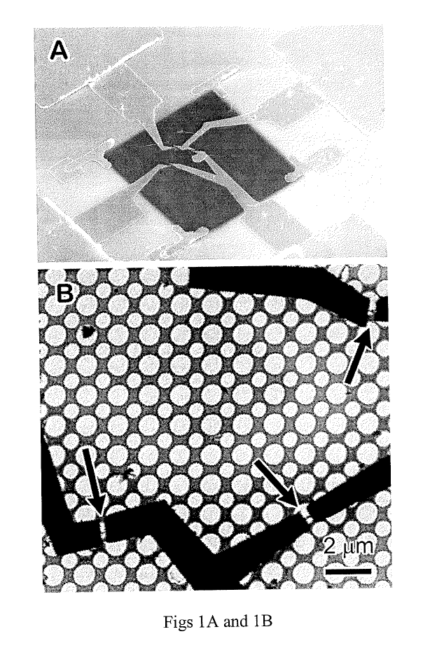

In particular, the response producing electron transport device was fabricated as follows: 500-800 nm of silicon oxide was grown on a silicon wafer, after which 10-20 nm of silicon nitride was deposited. The silicon was then selectively back-etched with potassium hydroxide (KOH). The oxide and nitride layers were exposed to hydrofluoric acid (HF), which removed silicon oxide and left the silicon nitride intact. Nanostructures were placed on the resulting membrane and located with scanning electron microscopy (SEM). Contacts to the nanostructures were patterned by electron beam lithography and deposited via electron-beam evaporation of gold. FIG. 1A shows an SEM image of several devices. For higher imaging resolution, holes were etched in the membrane before the nanostructures are deposited, as shown in FIG. 1B.

The device architecture described above provides a framework for the analysis of different response functions, including magnetic, electronic, mechanical, or chemical of a wide variety of nanostructures.

Using this structure the electronic transport of individual multiwall carbon nanotubes (MWCNTs) was analyzed. With this technique devices from fabrication to failure were imaged. Based on the analysis of the imaging of the devices, the inventors herein have found that initially the MWCNT is as a matter of course covered with residue from the device fabrication process. The residue is a by-product of the device fabrication process. This residue can be isolated surface debris, or, in some cases, an almost complete blanketing with gold nanoparticles. By examining the response of the device to progressively larger applied voltages, the cleaning of the MWCNT, annealing and erosion of the contacts, substrate alteration, and finally, failure of the MWCNT were observed. By monitoring the electronic transport while simultaneously imaging via TEM, the techniques in accordance with the embodiments of the present invention enable the correlation of the structural modifications with changes in electronic properties of the nanostructured device.

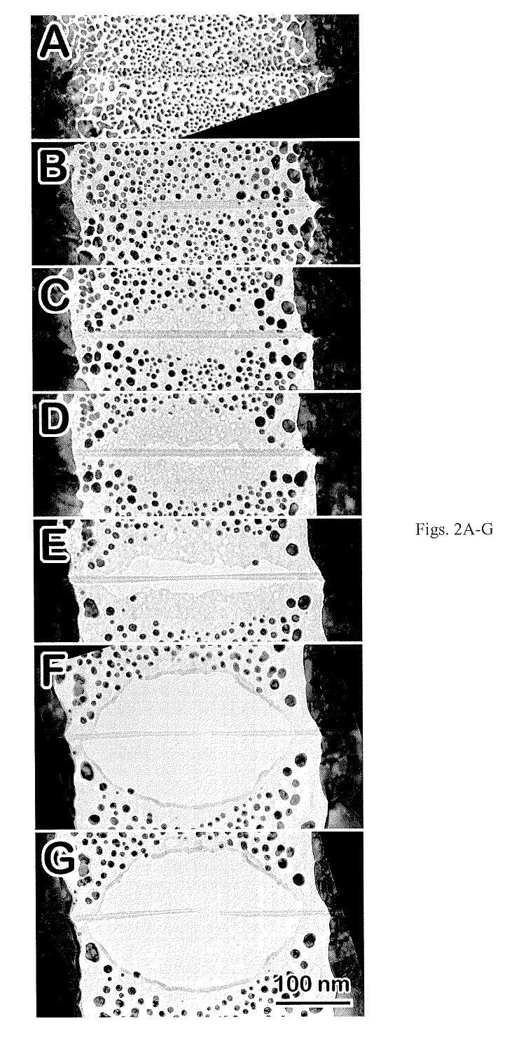

The FIG. 2 image set shows images that follow a representative MWCNT device through the sequence of manipulations. As fabricated (FIG. 2A), the device has a residue of gold nanoparticles, that are a by-product of the device fabrication process. The nanoparticle coverage on the surrounding continuous membrane serves as a useful temperature diagnostic.

Device operation begins in the low-bias regime (e.g., less than 200 mV), which produces no apparent structural modification on the short time scale of this experiment. In this limit, the devices typically exhibit a linear current-voltage (I-V) relationship, with resistances on the order of 10 kΩ. As the voltage is increased, however, nonlinearities start to appear in the I-V, and at approximately 1V the contact edges smooth and recede, with a corresponding increase in resistance. The rising of the applied voltage was continued and the cleaning of the MWCNT was observed, as seen in FIG. 2B. Heat dissipation in the MWCNT causes nearby gold nanoparticles to evaporate, while nanoparticles further away coalesce into larger particles.

Annealing of the contacts began shortly thereafter and was accompanied by a reduction in the resistance of the device. Both contacts became smoother and the grain size approximately doubled, as seen in FIG. 2C. Generally, the MWCNTs also became much cleaner at this stage, although some gold nanoparticles still adhered at the edges. Applying current sufficient to anneal the contacts and clean off surface contamination can change the total device resistance without modifying the nanostructure itself Afterwards, repeatability during normal operation was improved. Manufacturing processes incorporating similar heat treatment can produce more uniform, reliable devices.

To simulate prolonged device operation while avoiding excessive beam damage, the input power was further increased, which results in localized disintegration of the silicon nitride membrane. FIG. 2D shows a hole forming near the center of the MWCNT. Where the substrate is absent, images of the MWCNTs can be obtained with higher resolution. Suspending nanostructures also eliminates coupling to the substrate during transport measurements.

The evaporation of nanoparticles and the decomposition of the membrane revealed a temperature distribution that peaked on the MWCNT midway between the contacts. From the melting point of gold nanoparticles (e.g., see K. Koga, T Ikeshoji, and K. Sugawara, Physical Review Letters 92 (2004)) it was estimated that by FIG. 2D the MWCNT has reached a temperature in excess of 1200K, and yet it still showed no damage and continued to function as an effective conductor. The location of the temperature peak (i.e., midway between the contacts) indicates that the MWCNT was a diffusive conductor, since ballistic conduction would show dissipation only at the contacts.

Further increasing the voltage drove the MWCNT into current saturation and initiated the failure of the MWCNT. As seen in FIGS. 2E and 2F, the MWCNT first becomes thinner, with a corresponding discrete resistance increase, discussed in more detail below. Decreasing the applied voltage interrupted the failure process, allowing time for the acquisition of high magnification images. When the process was allowed to continue (i.e. increasing the current flow through the MWCNT), the MWCNT ultimately failed, as is shown on FIG. 2G.

### Analysis—Example 1

The electrically-driven thinning of MWCNTs seen in the FIG. 2 image set was first observed in TEM studies of bare MWCNTs (e.g., see Cumings, P. G. Collins, and A. Zettl, Nature 406, 586 (2000)). The electrically-driven thinning of MWCNTs has been explored both for its physical implications (e.g., see J. Cumings, P. G. Collins, and A. Zettl, Nature 406, 586 (2000); and B. Bourlon, D. C. Glattli, B. Placais, J M. Berroir, C. Miko, L. Forro, and A. Bachtold, Physical Review Letters 92 (2004)) and as a method to modify MWCNTs for use in nanoelectromechanical systems (NEMS) (e.g. see B. Bourlon, D. C. Glattli, C. Miko, L. Forro, and A. Bachtold, Nano Letters 4, 709 (2004); and A. M. Fennimore, T. D. Yuzvinsky, B. C. Regan, and A. Zettl, AIP Conference Proceedings 723, 587 (2004)).

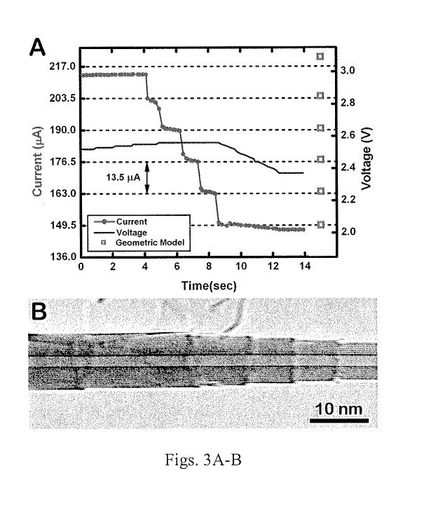

FIG. 3A shows the details of the time development of the electronic transport corresponding to the thinning effect seen in FIGS. 2D and 2E. From time t=0, the voltage is slowly increased in 10 mV steps to 2.56 V. A discrete step in the current response occurs at 2.55 V, followed by four more at 2.56 V. The voltage is then decreased, and the current decreases proportionally. The first current step, from 213.5 μA, is approximately 25% smaller than the following four (˜13.5 μA). Live imaging during this time period showed five discrete thinning events of the MWCNT, each simultaneous with a step down in current. FIG. 3B is a high-resolution image taken immediately after the steps were observed, showing that the five outermost walls have been removed from the MWCNT. This data provides an indication of the discrete wall-by-wall failure, in which each current step corresponds to the removal of the outennost intact wall.

The mechanism by which these walls are removed is uncertain. Various studies of similar devices in ambient atmosphere have attributed wall removal to oxidation. However, the failure documented herein occurs in high vacuum, where oxidation is unlikely to play a significant role. Furthermore, Joule heating of MWCNTs essentially halts oxidation in similar vacuum conditions (e.g., see T. D. Yuzvinsly, A. M. Fennimore, W. Mickelson, C. Esquivias, and A. Zettl, Applied Physics Letters 86 (2005)). Consequently, in the absence of air, an alternate mechanism is likely to be responsible for wall removal. While not being limited to any one particular theory, it is known that electron backscattering in nanotubes at high bias generates optical and zone-boundary phonons (e.g., see Z. Yao, C. L. Kane, and C. Dekker, Physical Review Letters 84, 2941 (2000)), which may lead to structural failure in the high current limit.

In accordance with the techniques of the embodiments of the present invention, the correlation of electronic transport with high-resolution imaging allows for quantitative examination of competing models of MWCNT transport. In previous studies of thinning in MWCNT devices, the imaging was perfonned after the fact and only determined the external dimensions of the MWCNT. The internal structure of the nanotube, including the core size and number of walls, could not be determined. The techniques as embodied by the present invention enable the direct observation of how many walls are removed, when they are removed, and over what length.

### Discussion—Models of Electrical Conduction in MWCNTs—Example 1

One model (e.g., see P. G. Collins, M Hersam, M. Arnold, R. Martel, and P. Avouris, Physical Review Letters 86, 3128 (2001)) attributes the current steps to the wall-by-wall failure of a saturated MWCNT, and posits that each wall carries the same current. This model implies proportionality between the current and the number of remaining walls. FIG. 3B shows five walls removed from a total of 12. Extrapolating the observed current staircase for seven more steps from ˜150 μA, this model predicts a current of ˜50 μA even after all the walls have been destroyed.

Another model for MWCNT conduction is one in which current is carried solely by the outer wall, as was reported in measurements of the Aharonov-Bohm effect in MWCNTs at low temperatures (e.g., see A. Bachtold, C. Strunk, J. P. Salvetat, J. M. Bonard, L. Forro, T. Nussbaumer, and C. Schonenberger, Nature 397, 673 (1999)). Adapting this model, which was developed for the low bias limit, to the present example, it is then assumed that as each wall fails, conduction passes to the outermost intact wall. To explain the equal current steps, it is assumed that the current carrying capacity of each wall is linearly proportional to its circumference. For an outer diameter of 9.5 nm (as measured from TEM images) and the measured initial current of 213.5 μA, this model predicts current steps of 15.3 μA, which is substantially higher than the measured value of 13.5 μA. From the examination of these two models it can be concluded that under the above operating conditions, the conduction through the MWCNT is neither solely in outermost wall, nor is it equally divided among the walls.

Analyzing the MWCNT as if it were a tube of bulk material with a hollow inner core gives competitive agreement with the data. Using the high resolution images, the MWCNT geometry was measured and the expected resistance assuming an isotropic conductivity tensor was calculated. The material's resistivity of approximately 1.9×10⁻⁶ Ω m was calculated from the device's final resistance and geometry, allowing for one free parameter, namely the contact resistance (2.2 kΩ). Surprisingly, this model fits the data rather well, as shown in FIG. 3A. The singular exception is the first current step, but this step is anomalously small according to all three of the models considered above. The reduced current carrying capacity of the original outer wall may be attributable to damage by TEM beam exposure or surface contaminants.

The models of electronic conduction in MWCNTs discussed above have different strengths. Describing the shells as discrete conduction channels explains the wall-by-wall failure mode confirmed herein. Describing the MWCNT as an isotropic conductor provides little insight into the origin of this failure mode, yet gives a better accounting of the relationship between current and structure. Data obtained with the combination of in situ device operation and high resolution imaging in accordance with the embodiments of the present invention can be used to test more sophisticated models of electronic transport in MWCNTs. These same techniques can be applied to obtain unique insights into the fundamental physics of other nanoscale systems.

Multi-wall carbon nanotubes (MWCNT) are a very stiff, robust material. Due to their mechanical properties and their high aspect ratios, MWCNTs attached to atomic force microscope (AFM) tips allow for greater resolution and durability. It has been shown that MWCNTs can be elastically deflected to fairly large angles and then forced to buckle elastically. This buckle is undone, however, when the probe is removed. The embodiments of the present invention provide a system and a method where MWCNTs are structurally reformed in a permanent manner. The example below describes the permanent reforming of MWCNTs and uses in situ transmission electron microscope (TEM) measurements for the mechanical properties of MWCNTs, while they are being reformed.

### EXAMPLE 2

This example describes how the carbon nanotubes were subjected to bending, buckling and annealing while inside a transmission electron microscope. A piezo-driven nanomanipulator was used as the response producing member. Using the piezo-driven nanomanipulator, individual nanotubes were contacted and their shape was modified. The nanotubes bent elastically until the strain became too large, causing the nanotube to inelastically bend or buckle. This buckling is reversible and reproducible, with the buckle occurring in the same location on the nanotube. The buckle was annealed and made permanent by passing current through the nanotube. Operating with an atomic force microscope tip inside the microscope, the force as the nanotube was bent and buckled was measured. These measurements showed that the force increased linearly with displacement until the nanotube buckled and then the force decreased and remains constant.

The setup used a nanofactory manipulation stage capable of two probe electrical measurements. For this example, as-grown MWCNT fibers were attached to a platinum wire with conducting epoxy and fixed to the TEM stage. For the probe, either an etched tungsten wire, another nanotube fiber, or a platinum wire was used. This wire was then placed in a brass “hat”, which was attached to a piezoelectric tube. Coarse motion was achieved with stick-slip motion of the “hat,” using voltage pulses to the piezoelectric tube, and fine motion was achieved using voltage-induced deflection.

By finely manipulating the probe, the individual MWCNT of choice were addressed. The electrical probes were used to shed the outer walls of the MWCNT, extract the inner core, move metals on the inside or outside of the MWCNT (e.g., as described above in Example 1), or the MWCNT were physically distorted. MWCNTs, when approached in this manner usually have a two-probe resistance in the range of 5-100 kΩ. After contacting the MWCNT, it was bent either by laterally deflecting it or by straining it along its axis. The former does not allow for large straining, because the MWCNT can slip off the probe. The latter, however, allows for large strain. When strained, MWCNTs bend elastically. However, at a certain critical strain, the MWCNT buckled relieving the stress pent up due to the large strain. This buckling was reversible. When the probe was removed, the MWCNT returned to its original form without any observable defects. This buckling was reproducible and occurred in the same location, possibly due to defects or locations of large stress. Buckling was indirectly observed using an AFM reproducibly and repeatedly, with no evidence of damage.

When the nanotube buckles, no large effect was seen in the two probe resistance. This was unexpected. However this observation is uncertain, due to the inability to quantify contact resistance, which could change when pressure is applied. However, the buckling of a MWCNT does not completely shut the conducting channels. Although this geometry is not ideal for measuring resistance, using the MWCNT as a self-heater is useful. By driving current through the MWCNT, the kink of the buckled MWCNT was made permanent.

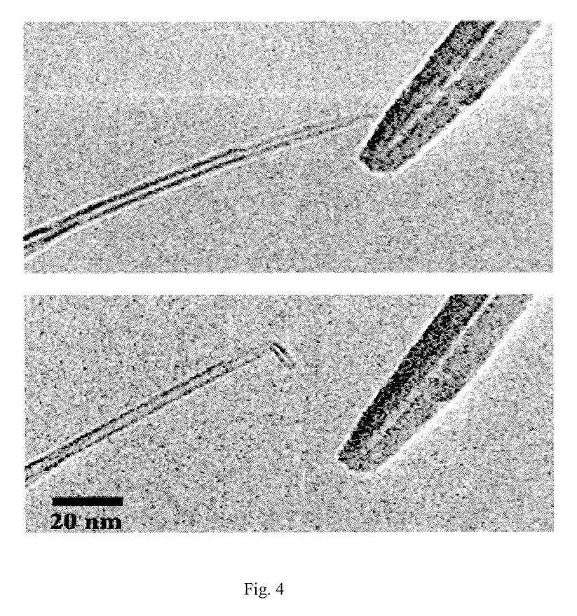

FIG. 4 shows a MWCNT before buckling (upper) and after the kink has been annealed (lower). This MWCNT was approached by a larger MWCNT used as the probe. The circuit resistance was approximately ˜100 kΩ. Current was slowly increased to 11 μA and then the probe was removed. When the probe was removed, the kink remained in the MWCNT. The current through the MWCNT was sufficient to heat it to a temperature sufficient for the bonds to rearrange within the MWCNT. The power dissipated was approximately 11 μW, which is much lower than that required to damage the walls of the nanotube.

While MWCNTs can buckle and unbuckle reversibly, this example shows that their structure can also be changed permanently. One application for such MWCNTs is their use as probes for nanoscale manipulations. The results of this example show the possibility that MWCNT can be made into probes of different geometries.

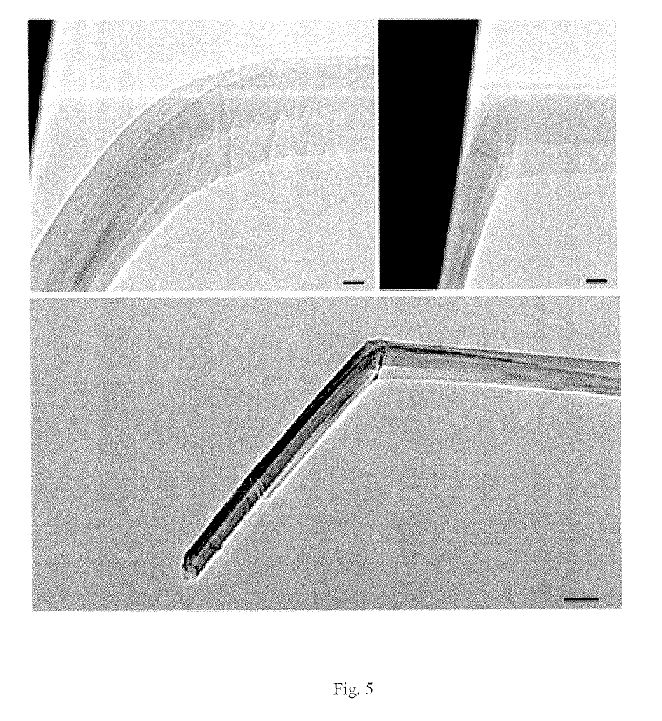

In addition to buckling MWCNTs and subsequently making them permanently buckled by current-induced heating, the MWCNTs were also bent very close to the threshold of buckling and electrical current was passed through them. The heating of the MWCNTs while in this high strain geometry causes the MWCNT to reform into the buckled geometry. FIG. 5A shows a MWCNT at the brink of buckling. After a current of 180 μA, the MWCNT buckles, as shown in FIG. 5B. After the probe is removed, the MWCNT remains kinked, as is shown in FIG. 5C. By applying heat to the MWCNT it relaxed into the buckled geometry. This suggests that the buckled MWCNT exerts a lower force on the probe.

To determine whether the force applied by the bent nanotube was larger or smaller than the buckled nanotube, the setup was modified to employ an AFM tip. By loading an AFM tip onto the stationary side and placing the MWCNTs on a platinum wire on the movable side, force measurements were obtained while watching a MWCNT buckle. The AFM was fixed to the stationary side, so that the deflection could be measured as a shift in position on the video screen. Steps were taken to minimize drift of the microscope. In the time frame of the experiment, the drift was negligible.

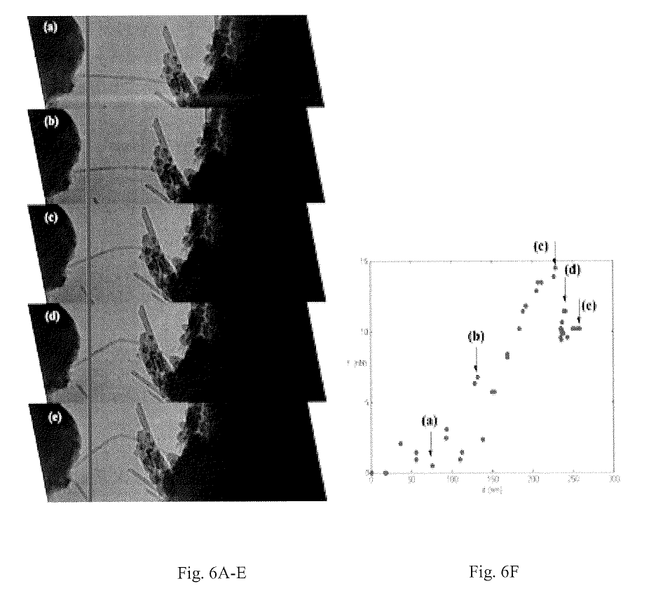

FIGS. 6A-E show a time sequence of an AFM tip contacted to a MWCNT during bending and buckling. On the left side of the images is an AFM tip with a force constant of 0.3 N/m. The line, L, indicates the AFM tip equilibrium position. FIG. 6F shows the force exerted on the MWCNT as a function of MWCNT displacement with markers indicating the force and position of FIGS. 6A-E. Before the MWCNT contacts the AFM tip there is no deflection. When the MWCNT first comes into contact with the AFM tip (FIG. 6A), there is some initial slipping causing noisy data. However, after FIG. 6B the MWCNT is well affixed to the AFM tip and the data is cleaner. The MWCNT acts as a linear spring until right after FIG. 6C. This is when the nanotube begins to buckle (FIG. 6D). After the MWCNT buckles, it acts like a constant force spring (FIG. 6E). The bending MWCNT has a spring constant of 0.1 N/m until it buckles. After buckling, the force exerted on the AFM tip drops from 15 nN to about 10 nN and remains constant for an additional 20 nm of axial compression. This agrees well with previous theoretical work on single wall carbon nanotubes (SWCNT). Yakobson et al. theorized that under axial compression a SWCNT would acts as a linear spring until a bending angle of about 60°, when it would buckle. In addition they found that after buckling, the restoring force drops and remains more or less constant upon further compression. The TEM video (as shown in FIGS. 6A-E shows that the MWCNT begins to buckle at a bending angle of about 60°. This angle could be larger if the angle of buckling is out of plane. This was determined to be less than 10° out of plane making 600 an accurate estimate. The results of this example also agree with those theoretical findings that the force exerted by the nanotube decreases by approximately ⅓ after buckling. The fact that there is such good agreement between the theoretical paper of on Yakobson et al. on SWCNTs and the experimental results herein on MWCNTs is unexpected. This is unexpected, because the theoretical papers is related to single-wall carbon nanotubes (SWCNTs) and example above is relates to multi-wall carbon nanotubes (MWCNTs). These are different systems and one expects them to behave different structurally. The force at which the MWCNT buckles also agrees well with elastic theory.

In accordance with Euler compressive beam buckling theory, the compression force at which an elastic rod with one end clamped becomes unstable is given by
F_{cr}=π²Y I/4 l² Eqn. 1
Where Y is the Young's modulus, I is the area moment of inertia, and l is the length of the rod. I=π r⁴/4, where r is the radius of the rod. By applying this equation to the MWCNTs tested above, Young's modulus can be extracted. With F_{cr}=15 nN, r=10 nm and l=1.5 μm, which is a conservative estimate, we get that Y=1.7 TPa. This agrees well with Young's modulus of previous experimental studies. For reference, the MWCNTs are a little more than 8 times the Young's modulus of common steel.

MWCNTs, when compressed axially, bend elastically until the strain is too large at which point they buckle. When the compressive force is removed, the MWCNT returns to its original, straight shape. However, when current is passed through the MWCNT, bonds rearrange and the MWCNT structure is permanently changed. By heating a MWCNT on the verge of buckling, one can cause the nanotube to reform into the bucked geometry. The force during axial compression is linear with compression distance until the MWCNT buckles. When the MWCNT buckles, the force drops. Upon further compression, the force remains constant.

As will be understood by those skilled in the art, the present invention may be embodied in other specific forms without departing from the essential characteristics thereof. For example, instead of mechanically manipulating the MWCNTs, they can also be magnetically, chemically, or otherwise manipulated. These other embodiments are intended to be included within the scope of the present invention, which is set forth in the following claims.

What is claimed is:

1. A method for reshaping a nanostructure, comprising:
providing a nanostructure having an initial shape;
applying energy from a non-chemical energy source to the nanostructure; and thereby
reshaping the nanostructure to a reshaped geometry different from the initial shape.

2. The method of claim 1, wherein the applying energy from a non-chemical energy source step comprises:
one or more of a group consisting of:
applying one or more electromagnetic fields, laser heating, laser heating with one or more femtosecond pulses, electromagnetically heating, resistive Joule heating with direct or alternating currents, eddy current-induced resistive Joule heating, electric field dissipation, ion bombardment, electron bombardment, ponderomotive forces, Lorentz magnetic forces, and laser tweezers.

3. The method of claim 1, wherein the nanostructure comprises:
one or more of a group consisting of:
a carbon nanotube, carbon nanotubes, carbon nanowires, a silicon nanotube, a silicon nanowire, silicon nanotubes, silicon nanowires, a gold nanowire, or gold nanowires.

4. The method of claim 1, further comprising:
deforming at least a part of the nanostructure prior to the applying energy step.

5. The method of claim 3, wherein the carbon nanotube is a multi-walled carbon nanotube.

6. The method of claim 1, wherein said applying energy from a non-chemical energy source produces a result comprising:
one or more of a group consisting of:
a cleaning, an annealing, a bending, a buckling, and combinations thereof.

7. The method of claim 1, wherein said reshaping step comprises deforming at least part of the nanostructure from the initial shape to the reshaped geometry.

8. The method of claim 7, wherein said deformation comprises an elastic deformation or a plastic deformation, or combinations thereof.

9. The method of claim 1, further comprising:
monitoring the reshaping step using a monitor device, said monitor device comprising:
one or more of a group consisting of:
a electron microscope, a tunneling electron microscope, a resistance measurement, a voltage measurement, a current measurement, a capacitance measurement, an optical measurement, and an optical image.

10. A method for cleaning a nanostructure, comprising:
cleaning a nanostructure by applying energy from a non-chemical energy source.

11. The method of claim 10, wherein the non-chemical energy source comprises:
one or more of a group consisting of:
applying one or more electromagnetic fields, laser heating, laser heating with one or more femtosecond pulses, electromagnetically heating, resistive Joule heating with direct or alternating currents, eddy current-induced resistive Joule heating, electric field dissipation, ion bombardment, electron bombardment, ponderomotive forces, Lorentz magnetic forces, and laser tweezers.

12. The method of claim 10, further comprising:
monitoring the cleaning using a monitor device, said monitor device comprising:
one or more of a group consisting of:
a electron microscope, a tunneling electron microscope, a resistance measurement, a voltage measurement, a current measurement a capacitance measurement, an optical measurement, or an optical image.

13. The method of claim 12, wherein the nanostructure comprises: one or more of a group consisting of:
a carbon nanotube, carbon nanotubes, carbon nanowires, a silicon nanotube, a silicon nanowire, silicon nanotubes, silicon nanowires, a gold nanowire, and gold nanowires.

14. The method of claim 13, wherein the carbon nanotube is a multi-walled carbon nanotube.

15. The method of claim 10, wherein said non-chemical energy source comprises:
applying electric current to the nanostructure through the passage of an electrical current of sufficient magnitude to clean the nanostructured device, yet low enough to prevent an undesired physical breakdown of the nanostructured device.

16. A nanostructure reshaping device, comprising:
a nanostructure with an initial resting shape;
a controller that imparts a shape change on the nanostructure from the initial resting shape; and
a non-chemical energy source that is applied to the shape changed nanostructure, which results in a change in the initial resting shape.

17. The method of claim 16, wherein the nanostructure comprises:
one or more of a group consisting of:
a carbon nanotube, carbon nanotubes, carbon nanowires, a silicon nanotube, a silicon nanowire, silicon nanotubes, silicon nanowires, a gold nanowire, and gold nanowires.

18. The method of claim 17, wherein the nanostructure is a carbon nanotube.

19. The method of claim 18, wherein the carbon nanotube is a multi-walled carbon nanotube.

20. The method of claim 17, wherein the nanostructure is a silicon nanotube.
